(19) United States
(12) Patent Application Publication
(10) Pub. No.: US 2026/0230645 A1
(43) Pub. Date: Aug. 6, 2026

(54) LEARNING-BASED PREDICTIVE CODING FOR DYNAMIC POINT CLOUDS

(71) Applicant: InterDigital VC Holdings, Inc., Wilmington, DE (US)

(72) Inventors: Junghyun AHN, New York, NY (US); Jiahao PANG, Plainsboro, NJ (US); Dong TIAN, Boxborough, MA (US)

(21) Appl. No.: 19/147,766

(22) PCT Filed: Jan. 3, 2024
(86) PCT No.: PCT/US2024/010140

§ 371 Date: Jul. 14, 2025

Related U.S. Application Data
(60) Provisional application No. 63/439,241, filed on Jan. 16, 2023.

(51) Int. Cl. H04N 19/597; H04N 19/137; H04N 19/159; H04N 19/176

(52) U.S. Cl. CPC H04N 19/597; H04N 19/137; H04N 19/159; H04N 19/176

(57) ABSTRACT

In one implementation, we introduce a dynamic point cloud compression (DPCC) architecture which learns how to code each spatial partition (block) based on the nature of the points in the block. A block of current frame that has high correlation to a block in the previous (reference) frame is defined as “inter mode block”. Otherwise, the block with less temporal correlation can be defined as an “intra mode block”. These blocks combined in one PC frame can improve the coding performance since it simplifies the packing of various residual features in a point cloud (PC) frame. Besides, it can also enhance the quality of reconstruction as a proper feature learning method can be assigned on each block. Moreover, the proposed two-level, block- and frame-level architecture for DPCC and the novel block-level motion compensation subtracted within the feature space help the decoder to more robustly synthesize points.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### SUMMARY

According to an embodiment, a method of decoding a point cloud frame in a dynamic point cloud sequence is presented, comprising: decoding motion information for a current point cloud block, wherein said current point cloud block is inter coded; obtaining a reference point cloud block in a previously reconstructed point cloud frame for predicting said current point cloud block, based on said motion information for said current point cloud block; obtaining a feature representative of said reference point cloud block, using at least a point-based neural network; decoding residual feature information for said current point cloud block that represents a difference between said current point cloud block and said reference point cloud block; obtaining a feature for said current point cloud block, based on said decoded residual feature information and said feature representative of said reference point cloud block; and reconstructing positions of 3D points in said current point cloud block based on said feature for said current point cloud block, using at least another point-based neural network.

According to another embodiment, an apparatus for decoding a point cloud frame in a dynamic point cloud sequence is presented, comprising one or more processors and at least one memory coupled to said one or more processors, wherein said one or more processors are configured to: decode motion information for a current point cloud block, wherein said current point cloud block is inter coded; obtain a reference point cloud block in a previously reconstructed point cloud frame for predicting said current point cloud block, based on said motion information for said current point cloud block; obtain a feature representative of said reference point cloud block, using at least a point-based neural network; decode residual feature information for said current point cloud block that represents a difference between said current point cloud block and said reference point cloud block; obtain a feature for said current point cloud block, based on said decoded residual feature information and said feature representative of said reference point cloud block; and reconstruct positions of 3D points in said current point cloud block based on said feature for said current point cloud block, using at least another point-based neural network.

According to another embodiment, a method of encoding a point cloud frame in a dynamic point cloud sequence is presented, comprising: estimating motion information for a current point cloud block based on a current point cloud frame and a previously reconstructed point cloud frame; obtaining a reference point cloud block from a previously reconstructed point cloud frame for predicting said current point cloud block, based on said motion information for said current point cloud block; obtaining a first feature representative of said current point cloud block and a second feature representative of said reference point cloud block, using at least a point-based neural network; obtaining a difference between said first feature representative of said current point cloud block and said second feature representative of said reference point cloud block to form a residual feature; and encoding said residual feature.

According to another embodiment, an apparatus for encoding a point cloud frame in a dynamic point cloud sequence is presented, comprising one or more processors and at least one memory coupled to said one or more processors, wherein said one or more processors are configured to: estimate motion information for a current point cloud block based on a current point cloud frame and a previously reconstructed point cloud frame; obtain a reference point cloud block from a previously reconstructed point cloud frame for predicting said current point cloud block, based on said motion information for said current point cloud block; obtain a first feature representative of said current point cloud block and a second feature representative of said reference point cloud block, using at least a point-based neural network; obtain a difference between said first feature representative of said current point cloud block and said second feature representative of said reference point cloud block to form a residual feature; and encode said residual feature.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding point cloud data according to the methods described herein.

One or more embodiments also provide a computer readable storage medium having stored thereon point cloud data generated according to the methods described above. One or more embodiments also provide a method and apparatus for transmitting or receiving the point cloud data generated according to the methods described herein.

### BRIEF DESCRIPTION OF THE DRAWINGS

FIG. 1 illustrates a block diagram of a system within which aspects of the present embodiments may be implemented.

FIG. 2 illustrates learning-based PCC.

FIG. 3 illustrates learning-based dynamic PCC.

FIG. 4 illustrates an encoder of the proposed learning-based dynamic PCC, according to an embodiment.

FIG. 5 illustrates a decoder of the proposed learning-based dynamic PCC, according to an embodiment.

FIG. 6 illustrates block motion estimation of the ME/D module, according to an embodiment.

FIG. 7 illustrates reference block estimation of the ME/D module, according to an embodiment.

FIG. 8 illustrates block-wise residual subtraction of the BAᵢₙₜₑᵣ module, according to an embodiment.

FIG. 9 illustrates block-level synthesis with inter and intra modes in a frame, according to an embodiment.

FIG. 10 illustrates BSᵢₙₜₑᵣ module with motion compensation, according to an embodiment.

FIG. 11 illustrates a voxel analysis module (VA), according to an embodiment.

FIG. 12 illustrates a voxel synthesis module (VS), according to an embodiment.

### DETAILED DESCRIPTION

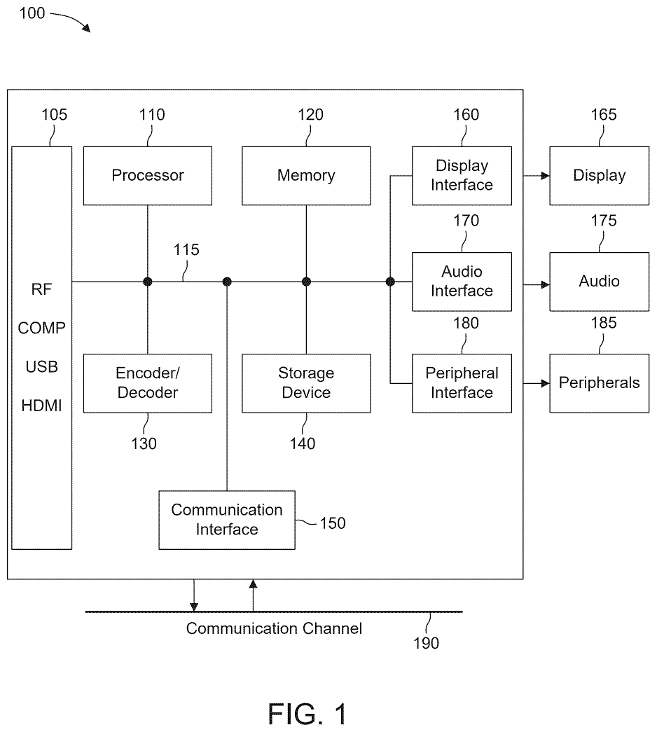

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

In order to perform processing or inference on a point cloud, efficient storage methodologies are needed. To store and process an input point cloud with affordable computational cost, one solution is to down-sample the point cloud first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down-sampled) into a bitstream through entropy coding techniques for lossless compression.

In addition to lossless coding, many scenarios seek lossy coding for a significantly improved compression ratio while maintaining the induced distortion under certain quality levels. To improve the coding efficiency, an efficient point feature extractor can be useful to improve the accuracy of the reconstruction within the given resource budget.

Along with the high interests in applying sparse convolution, the learning-based point cloud compression (PCC) frameworks are moving their interest towards the dynamic point clouds. Dynamic coding is a well-known approach in 2D video compression, but newer in the point cloud compression domain, especially for the learning-based PCC. In line with the evolution of sparse convolution, a new research area is forming around DPCC.

As the traditional dynamic coding approaches, using previously reconstructed frames for decoding current frames is useful to reduce the size of bitstream when compressing point cloud data. However, the points in the current frame could newly appear or could have disappeared from the previous (reference) frame. As such, a more sophisticated approach, e.g., a classification of points and blocks-of-points to inter (dynamic interpretation with previous frame) and intra modes would be required to deal with this complex situation.

Learning-based dynamic point cloud compression (DPCC) is a recent active research topic in which some previous works have been introduced. In the following, the related works on DPCC are described along with a two-level PCC architecture.

The sparsity and non-uniformity in a point cloud (PC) are issues that are encountered in many learning-based PCC approaches. One of the solutions is to design a two-level architecture by separating the point feature learning into voxel-based and point-based methods. A voxel-based approach is often achieved by applying CNN-based design for extracting feature vector on each downsampled 3D coordinate, but it is not efficient for a very sparse PC because features on the voxels become hard to propagate to their neighbors. For example, if a downsampled voxel merges only one point, then there is less neighbor information to be learnt. On the other hand, a point-based method can be useful to bridge this gap by analyzing a bigger block at once in a floating space. A block partitioning module first assigns the very sparse and non-uniform points to different blocks, then point features are extracted for each point with a shared MLP. The points within each block are grouped together for a block-level feature extraction (e.g., PointNet). The collection of these extracted block features forms a feature map and is fed to a voxel-based network for further feature aggregation. The finally aggregated feature map is coded into bitstream. On the decoder, this process is reversed. The coded feature map is sent to a voxel-based upsampling first, then a block-level point synthesis via a shared MLP.

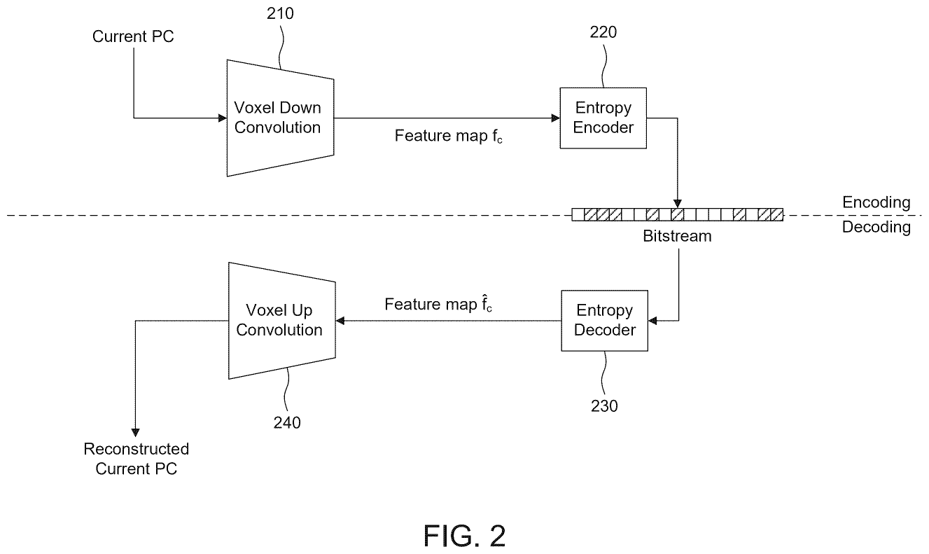

Before describing the current state-of-the-art on DPCC, a general learning-based PCC framework is depicted in FIG. 2. Firstly, a current PC frame is fed to a voxel-based downsampling module (210 “Voxel Down Convolution”) and generates a feature map f_{c}. This f_{c} is encoded by an entropy encoder (220) into a bitstream then decoded by an entropy decoder (230) as feature map \hat{f}_{c}. \hat{f}_{c} is upsampled back via a voxel-based upsampling module (240, “Voxel Up Convolution”) in the decoder to finally reconstruct the current PC frame. Note that in this framework the decoding of a current PC frame does not rely on any previously decoded PC frame. We call such a learning-based coding approach as an Intra coding method.

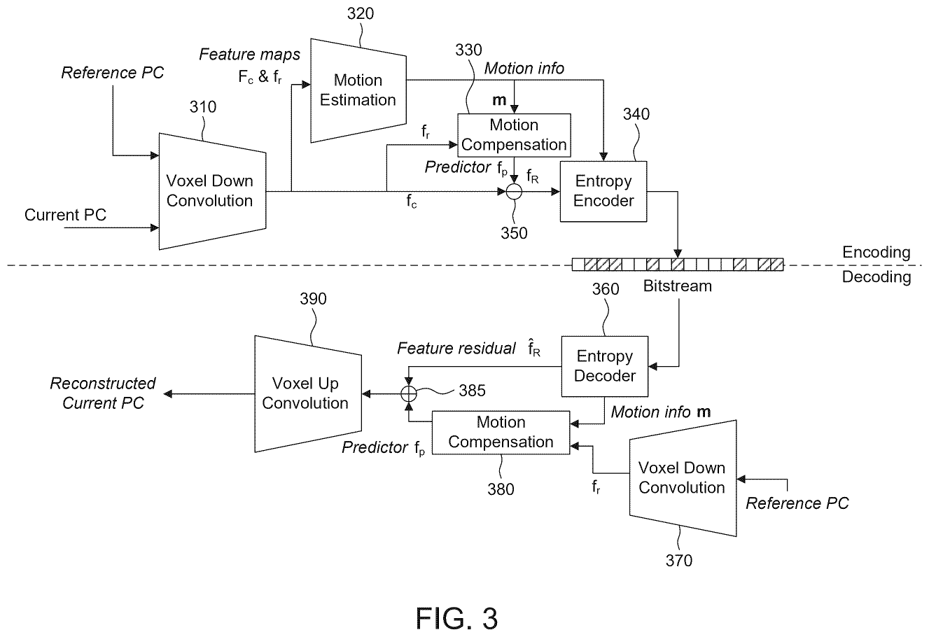

A typical approach on DPCC may take a previously decoded PC frame as reference to eliminate redundancy. As illustrated in FIG. 3, this reference PC frame along with the current PC frame are first processed by a voxel-based CNN (310, “Voxel Down Conv”) to transform the point clouds to a feature domain. These feature maps fᵣ (for the reference PC) and f_{c} (for the current PC) are used to estimate the motion information m from the reference to current frames. Then a motion compensation module (330) generates the predictor of f_{c} (denoted as fₚ) based on the feature map of the reference frame fᵣ and the estimated motion information m. This predictor fₚ is subtracted (350) from the current frame embedded feature f_{c} to generate a feature residual f_{R}. This f_{R} and the motion information m are entropy coded (340) into a bitstream.

On the decoder side, the previously decoded point cloud, i.e., the reference frame, is fed to the “Voxel Down Convolution” module to (370) obtain the feature map fᵣ. Note that the “Voxel Down Conv” modules in the encoder and the decoder are the same. Then fᵣ along with the decoded (360) motion information m, generates the predictor fₚ via the motion compensation module (370, same as the one on the encoder). Note that the addition (380) and subtraction operations in FIG. 3 are simply vector addition and subtraction. On the other hand, the “Voxel Up Convolution” module (390) on the decoder side is a voxel-based CNN which is to upsample the input feature map by convolutional layers.

In an end-to-end DPCC framework (see Tingyu Fan, et al., “D-DPCC: Deep Dynamic Point Cloud Compression via 3D Motion Prediction,” pp. 898-904, IJCAI 2022, hereinafter “Fan”), the architecture is designed following FIG. 3. This method embeds features of each frame directly via sparse convolutional layers and downsampling. Then, the feature map of the whole frame is predicted via motion estimation and the feature map of the reference PC. In Fan, the motion estimation module consists of a series of sparse convolutional layers with downsampling for computing the motion information, then the motion information is encoded. In the decoder, the decoded motion information and the feature map of the reference PC are fed to the motion compensation module.

There might be issues with this method. Firstly, the current and reference frames being fully embedded with downsampling could overgeneralize the extracted features. Some of the areas in a frame may not be suitable to be inter coded. Secondly, the motion estimation further down-samples the motion field through a sparse CNN. This could oversimplify the motion information, making it difficult to decode properly.

Another DPCC work (see Anique Akhtar, et al., “Inter-Frame Compression for Dynamic Point Cloud Geometry Coding,” arXiv preprint arXiv: 2207.12554 (2022), hereinafter “Akhtar”) proposes to predict the feature map of the current PC frame, f_{c}, using the reference PC alone, by employing a sparse CNN directly. This method generates a predictor of f_{c} by mapping fᵣ onto the downsampled voxel positions of the current frame without explicit motion estimation. The decoder hierarchically reconstructs the current frame by progressively rescaling the feature embedding.

Similar to Fan, the proposal by Akhtar also fully relies on a voxel-based operations and infuses the motion information implicitly into the embedding feature. This can cause similar problems to those described in Fan. For the above methods, the feature embedding and the motion information are generated by voxel-based methods. As such, this could be inefficient in coding dynamic point cloud with various sparsity and non-uniformity. These drawbacks can be mitigated by the proposed architecture, which will be described in the follows.

### Overall Architecture of the Proposed DPCC Framework

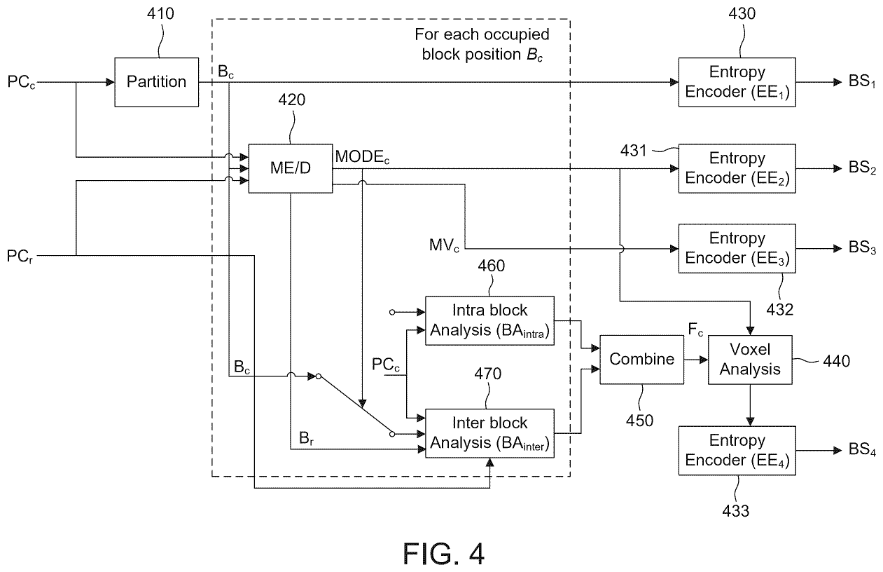

The encoder diagram of our proposal is illustrated in FIG. 4, according to an embodiment. Given the current point cloud PC_{c}, it is first fed to a “block partitioning module” (410), which divides the current point cloud uniformly in the 3D space, leading to a set of occupied blocks. An occupied block means there exists at least one 3D point within the block, otherwise it is an empty block which can be ignored in the encoding/decoding since there are no 3D points in it. The positions of all the occupied blocks are sent to the first entropy encoder EE₁ (430) for encoding, leading to the first bitstream BS₁.

Compared to the previous works, our proposal has the flexibility to assign different coding modes (either intra or inter) to different occupied blocks within the current point cloud frame. An occupied block encoded/decoded without relying on another block from a different frame is referred to as intra mode block; while a block relying on another block from a different frame for encoding/decoding is referred to as inter mode block.

Next, a motion estimation and mode decision module ME/D (420) is introduced. Its purpose is to determine whether an occupied block should be encoded under the intra or inter mode, and for those occupied blocks that are categorized as inter block, additional information will be output for subsequent inter-coding steps.

Particularly, suppose we have an occupied block from the current frame located at the 3D position B_{c}. For convenience, we also denote this occupied block by b_{c} in the following. Then, the 3D position B_{c}, the current frame PC_{c} and the reference frame PCᵣ are fed to the ME/D module, which outputs three quantities: i) the mode associated to be, either inter or intra, denoted as MODE_{c}; ii) estimated motion vector associated to b_{c}, denoted as MV_{c}, and iii) the position of the reference block on the reference frame PCᵣ, denoted as Bᵣ. For convenience, the reference block at position Bᵣ on the reference frame is also denoted as bᵣ. Essentially, bᵣ is the predictor of be from the reference frame PCᵣ.

The coding modes MODE of all occupied blocks be are then assembled as a mode map and passed to the second entropy encoder EE₂ (431) for generating the second bitstream BS₂. Aside from that, the motion vectors MV_{c} of all inter mode blocks are also passed to the third entropy encoder EE₃ (432) for generating the third bitstream BS₃.

Next, we proceed to encode the actual content within the occupied block. There are two branches that operate differently according to the categorization of an occupied block. For a block b_{c} categorized as an intra mode block, its coordinate B_{c} will be passed to the “intra block analysis module” (460, denoted as BAᵢₙₜᵣₐ). Aside from B_{c}, BAᵢₙₜᵣₐ also takes the current point cloud PC_{c} as input. Its purpose is to crop out the block be from PC_{c} according to the provided position B_{c}, then launch a point-based neural network to extract the feature vector of b_{c}. The obtained feature vector is denoted as f_{c}.

On the other hand, if a block b_{c} is categorized as an inter mode block, its coordinate B_{c} will be passed to the “inter block analysis module” (470, denoted as BAᵢₙₜₑᵣ). Aside from B_{c}, BAᵢₙₜₑᵣ also takes the reference block position Bᵣ, the current point cloud PC_{c} and the reference point cloud PCᵣ as inputs. The purpose of BAᵢₙₜₑᵣ is to compute the residual of b_{c} with respect to its predictor bᵣ in the feature space for encoding, so as to enhance the compression performance. Particularly, BAᵢₙₜₑᵣ access b_{c} and bᵣ according to the input positions Be and Bᵣ. Then it launches a shared point-based neural network (e.g., PointNet) to extract the features of be and bᵣ, leading to two feature vectors f_{c} and fₚ (subscript “p” means “predictor”), respectively. Then a residual feature vector fᵣ is computed via subtracting fₚ from f_{c}. The residual feature vector fᵣ is then output by BAᵢₙₜₑᵣ.

Note that compared to the previous work, our work introduces point-based neural networks to digest the raw point clouds, and therefore able to effectively analyze the input point cloud even if it is very sparse. Moreover, the “motion estimation and mode decision module” has access to the raw point clouds. Compared to the previous work which only uses block-wise features for motion estimation, our work provides more accurate estimated motion which further benefits the compression.

We note that, whether a block is classified as inter or intra, it always leads to a feature vector, f_{c} or fᵣ, respectively. Thus, the encoding of the features of PC_{c} can be unified. Particularly, the feature vectors of the occupied blocks are combined/assembled (450) as a feature map. The combined feature map is denoted as denoted as F_{c}. In the previous work without inter/intra combined, the feature map is a homogeneous feature map. In this work, the feature map F_{c} is a heterogeneous feature map.

F_{c} is then fed to the “voxel analysis module” (440, denoted as VA), which consists of a few convolutional layers operating in the voxel domain. The VA module (440) takes the mode map (indicating which blocks are inter mode blocks and which are intra mode blocks) and the feature map F_{c} as inputs, and down-samples the feature map F_{c} to further exploit the correlation between neighboring blocks. Since the feature map F_{c} is a heterogeneous feature map consisting of features from both the inter mode blocks and the intra mode blocks (indicated by the mode map fed to VA), the VA module processes F_{c} by taking this mode assignment into account, which is not the case for the previous works. In one embodiment, the VA module augmented the feature map F_{c} by one dimension indicating whether the associated block is an inter or intra mode block, followed by processing it with convolutional layers. The downsampled feature map is then passed to the fourth entropy encoder (433), leading to the fourth bitstream, BS₄. In one embodiment, BS₁, BS₂, BS₃, and BS₄ can be multiplexed into one bitstream.

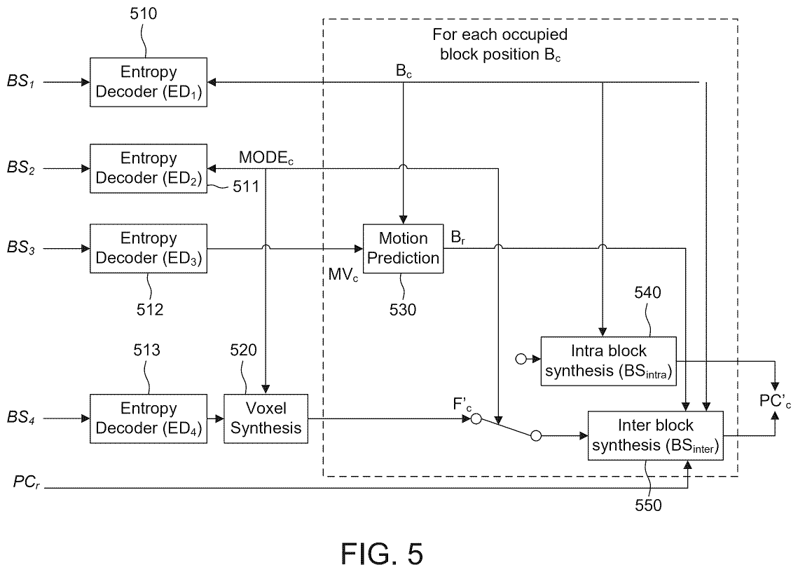

The proposed decoder diagram is provided in FIG. 5, according to an embodiment. Firstly, BS₁, BS₂, BS₃ and BS₄ are fed to the first, the second, the third and the fourth entropy decoders (510, 511, 512, 513, ED₁, ED₂, ED₃ and ED₄), generating the occupied block positions, the mode map, the motion vectors and the downsampled feature map, respectively.

After that, the downsampled feature map is fed to the “voxel synthesis module” (520, denoted as VS). The VS module consists of convolutional layers operated in the voxel domain, and its purpose is to upsample the input feature map, so as to obtain every individual feature vector associated with the occupied blocks. The upsampled feature map is denoted as F_{c}′. We note that the VS module takes not only the downsampled feature map but also the mode map of the occupied blocks as inputs. That is because the occupied blocks have different coding modes (either intra or inter), so the decoded feature map F_{c}′ is a heterogeneous feature map similar to the feature map F_{c} on the encoder side. To obtain a feature map F_{c}′ that benefits the quality of the reconstructed point cloud, the VS module also takes the mode map into account, which is different from the previous works. In one embodiment, the VS module upsamples the input feature map to match its size with F_{c}, followed by augmenting it by one dimension indicating whether the associated block is an inter or intra mode block. The obtained feature map is then passed to convolutional layers to obtain the output feature map F_{c}′.

Next, given an occupied block located as the position B_{c}, there are two branches for decoding, depending on whether the associated mode MODE_{c} is inter or intra. If MODE_{c} is intra, meaning that the associated block is an intra mode block, then the associated feature (denoted as F_{c}) is fed to the “intra-block synthesis module” (denoted as BSᵢₙₜᵣₐ) for decoding. BSᵢₙₜᵣₐ is a point-based neural network to decode the 3D points associated with the block b_{c}. In one embodiment, it applies a series of MLP layers for decoding the positions of the 3D points. BSᵢₙₜᵣₐ also takes the position B_{c} as input, so as to translate the decoded points, letting them to be located within the block position B_{c}. It is achieved by simply adding B_{c} to the coordinates of the decoded points.

However, if MODE_{c} is inter, meaning that the associated block is an inter mode block, then we compute the position of the reference block Bᵣ on PCᵣ with a motion prediction module. The motion prediction module (530) simply computes Bᵣ=B_{c}+MV_{c} where MV_{c} is the motion vector associated with the block b_{c}. Then based on Bᵣ, PCᵣ, and the (residual) feature F_{c} associated with the block b_{c}, the “inter-block synthesis module” (550, denoted as BSᵢₙₜₑᵣ) is applied for decoding the block b_{c}. The BSᵢₙₜₑᵣ operates as follows. Firstly, it crops the reference block bᵣ positioned at Bᵣ from the reference point cloud PCᵣ. Be reminded that bᵣ is a predictor of the block b_{c}. Then BSᵢₙₜₑᵣ passes bᵣ to a point-based neural network for feature extraction, leading to its feature vector fₚ. We note that the point-based neural network here is identical to the point-based neural network on the encoder side. Next, we add the residual F_{c} to fₚ, leading to the decoded feature of the block b_{c}-denoted as f_{c}′. In the end, similar to BSᵢₙₜᵣₐ, it applies a series of MLP layers for decoding the positions of the 3D points, followed by translating the decoded points, letting them to be located within the block position B_{c}. It is achieved by simply adding B_{c} to the coordinates of the decoded points.

By assembling all of the decoded occupied blocks (both inter mode and intra mode blocks), the reconstructed current point cloud PC_{c}′ is finally obtained.

### Block Motion Estimation and Mode Decision (ME/D) Module

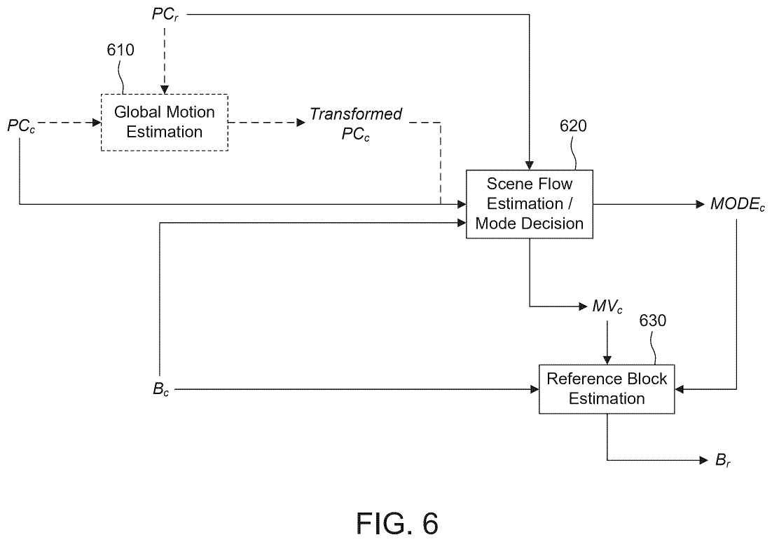

As shown in FIG. 6, the “ME/D” module consists of two sub-modules “scene flow estimation” (620) and “reference block estimation” (630), with an optional sub-module “global motion estimation” (610).

The “scene flow estimation” module (620) takes the current point cloud (PC_{c}), the reference (previous) point cloud PCᵣ, and the block position B_{c} of the current frame as inputs, then outputs block-wise motion vectors (MV_{c}) and their MODE_{c} decided by the confidence or errors generated during the computation of each MV_{c}. The learning-based scene flow estimation methods (see Xingyu Liu, et al. “FlowNet3D: Learning Scene Flow in 3D Point Clouds,” In Proceedings of the IEEE/CVF Conference on Computer Vision and Pattern Recognition, pp. 529-537, 2019, hereinafter “Liu”, and Haiyan Wang et al., “FESTA: Flow Estimation via Spatial-Temporal Attention for Scene Point Clouds,” In Proceedings of the IEEE/CVF Conference on Computer Vision and Pattern Recognition, pp. 14173-14182, 2021, hereinafter “Wang”) are examples of this module.

The first method (Liu) estimates scene flow from a pair of consecutive PC frames. It introduced “Flow Embedding” layer that learns to correlate two consecutive point clouds, and a “Set Upconv” layer that learns to propagate features from one to another PC. The second method (Wang) spatially enhances the selection of group query points for better flow correspondence between two frames. In addition, it also temporally improves the points searching area for the flow embedding step.

The “reference block estimation” module (630) takes MV_{c}, MODE_{c}, and B_{c} as inputs. Then output Bᵣ, which is the block position in a reference frame corresponding the current frame. Bᵣ is computed by adding the corresponding B_{c} and MV_{c} only if the MODE is decided as inter.

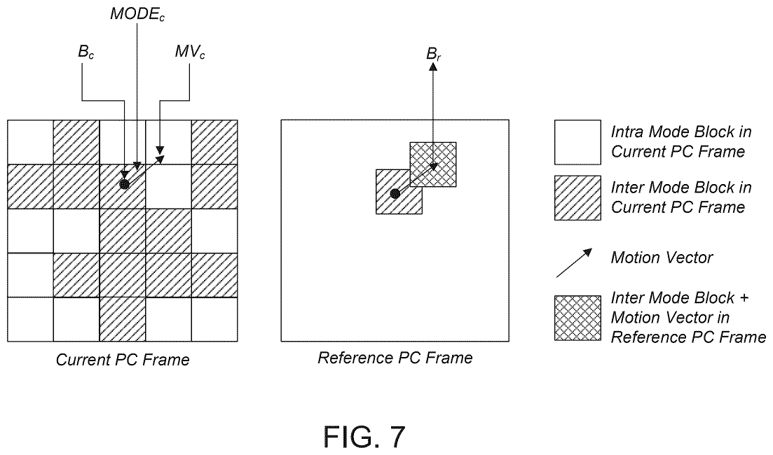

Further details are illustrated in FIG. 7 on how Bᵣ is computed. For a PC_{c} frame, the mode for each block is defined by MODE_{c}. An example block position B_{c} is depicted as a dot in an inter mode block in the PC_{c} frame. The arrow represents a motion vector MV_{c} estimated on B_{c}. As the size of current (PC_{c}) and reference (PCᵣ) frames are identical, it is possible to transfer B_{c} and MV_{c} onto the reference PC frame. The corresponding reference block position Bᵣ can be calculated by adding both B_{c} and MV_{c}. Bᵣ is the output of the ME/D module.

In another embodiment, the “global motion estimation” module can be added before the scene flow estimation.

The “global motion estimation” solves the following equation,

$${P}_{r}^{T} = {M}_{g} \cdot {P}_{c}^{T} , where {P}_{c}^{T} and {P}_{r}^{T}$$

are transposed current and reference 4D points with homogeneous coordinate filled with 1, respectively. The matrix M_{g} is the unknown global transformation matrix that needs to be approximated.

A point-to-point or point-to-plane ICP (see Paul J. Besl and Neil D. Mckay, “A Method for Registration of 3D Shapes”, PAMI, 1992, hereinafter “Besl”, Y. Chen and G. G. Medioni, “Object modelling by registration of multiple range images”, Image and Vision Computing, 10 (3), 1992, hereinafter “Chen”) are examples of this global transformation. In general, the ICP algorithm iterates over two steps: 1) Find correspondence set K (selection of points considered as correspondence between the current and reference frames) from reference point cloud Pᵣ^{T}, and current point cloud

$${P}_{c}^{T}$$

transformed with current transformation matrix M_{g}; and 2) Update the transformation M_{g} by minimizing an objective function E(M_{g}) defined over the correspondence set K. The point-to-point ICP algorithm (Besl) uses the objective function

$$E ( {M}_{g} ) = {\sum }_{K} {‖ {P}_{r}^{T} - {M}_{g} {P}_{c}^{T} ‖}^{2}$$

and the point-to-plane ICP (Chen),

$$E ( {M}_{g} ) = {\sum }_{K} {( ( {P}_{r}^{T} - {M}_{g} {P}_{c}^{T} ) \cdot {N}_{r}^{T} )}^{2} , where {N}_{r}^{T}$$

are normals in the reference points in K.

The “scene flow estimation” sub-module takes the actual transformed current PC frame

$${M}_{g} \cdot {P}_{c}^{T}$$

and the reference PC frame

$${P}_{r}^{T}$$

as inputs without the homogenous coordinates for both PC frames.

### Block-Level Analysis Module for Inter Mode (BAᵢₙₜₑᵣ)

As depicted in FIG. 7, the inter (for temporal analysis) and intra (for spatial analysis) modes are selected via the “ME/D” module in FIG. 4. The feature of the intra mode block is extracted and aggregated directly from the current PC frame (PC_{c}). On the other hand, the residual feature of the inter mode block is extracted and aggregated from the difference between the current (PC_{c}) and the reference (PCᵣ) frames. The block-wise motion vectors estimated by “Scene Flow Estimation” module (see FIG. 6) locate a prediction block. The aggregated feature (fᵣ) of reference points within the prediction block and the aggregated feature (f_{c}) of current points within the corresponding current block are extracted.

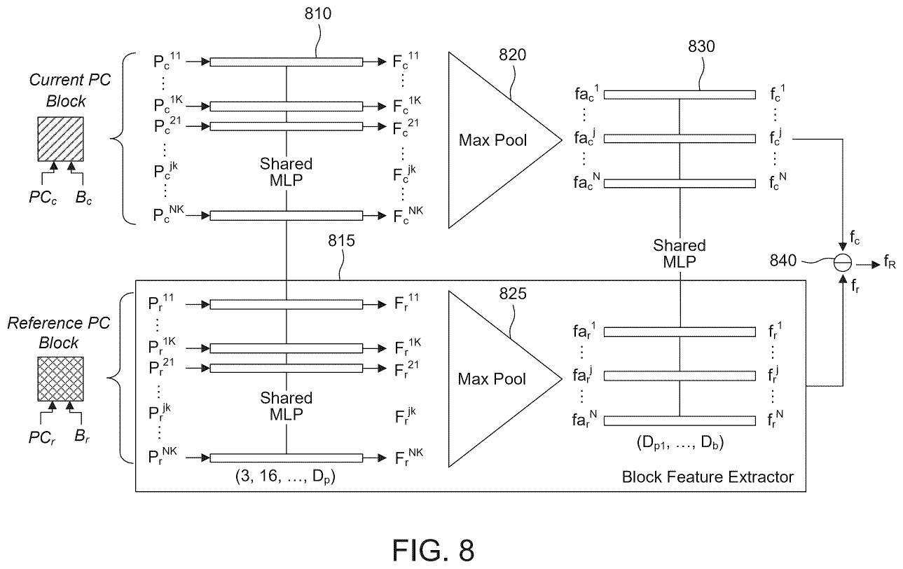

Next, the residual feature of the inter mode blocks (denoted by f_{R}) are computed by subtracting fᵣ from f_{c} via the subtraction module. For more details, the BAᵢₙₜₑᵣ module is illustrated in FIG. 8. We note that in one embodiment, the subtraction module ⊖ is implemented by simple vector subtraction i.e., f_{R}=f_{c}−fᵣ, In another embodiment, the subtraction module is implemented by a neural network. It first concatenates the two features fᵣ and f_{c}, followed by passing it to a series of convolutional layers, then the output of the convolutional layers is the residual feature f_{R}.

In particular, the block-wise features f_{c} and fᵣ are extracted by two PointNet-like feature extractors. As illustrated in FIG. 8, for each block (B_{c} or Bᵣ) the point-wise feature is extracted through a shared MLP (810, 815) then aggregated with a max pooling (820, 825) aggregated features: fa_{c} and faᵣ). Then fa_{c} and faᵣ are embedded through a block-wise shared MLP (830). These features generated in current and reference blocks are defined as f_{c} and fᵣ, respectively. By subtracting (840) these features, the block-wise residual feature fₚ is obtained for the frame-level analysis (VA module in FIG. 4).

### Block-Level Synthesis Module

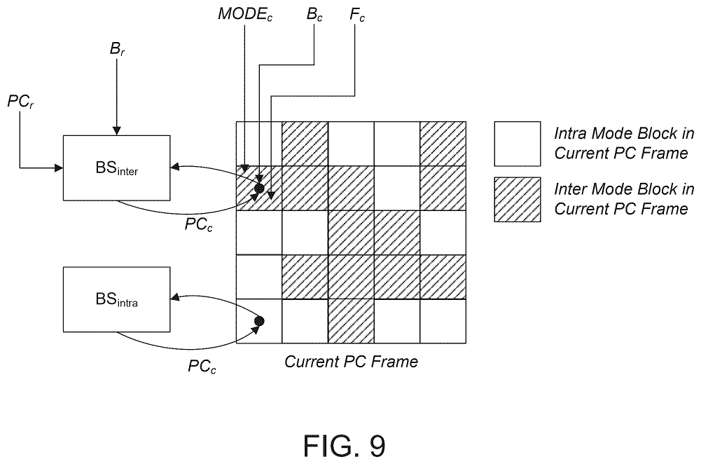

The block-level synthesis is illustrated in FIG. 9. The point synthesis methods (BSᵢₙₜₑᵣ or BSᵢₙₜᵣₐ) vary by the block mode (inter or intra, but not limited to) analyzed during the encoding process. The MODE_{c} decides the mode of each block in PC_{c}, and the block position B_{c} defines the position of each block. For each B_{c} a corresponding upsampled F_{c} is given. These block attributes are given to both BSᵢₙₜₑᵣ and BSᵢₙₜᵣₐ modules. They output the reconstructed current point cloud PC_{c}.

For intra mode, the block residual synthesis is simply implemented as a series of MLP layers, similarly done in a commonly owned application PCT/US2022/052861 entitled “Scalable Framework for Point Cloud Compression”. Specifically, given a block-wise feature of an intra block, it will be fed to the MLP layers for decoding. The MLP layers first generate the 3D coordinates of the points in the decoded block. These generated 3D coordinates are local coordinates, i.e., they are relative coordinate with respect to the center position of the intra mode block. Therefore, by adding back the center position of the intra mode block to the 3D points generated by the MLP layers, we finally reconstruct that intra mode block on the decoder side.

The BSᵢₙₜₑᵣ Module with Block Motion Compensation

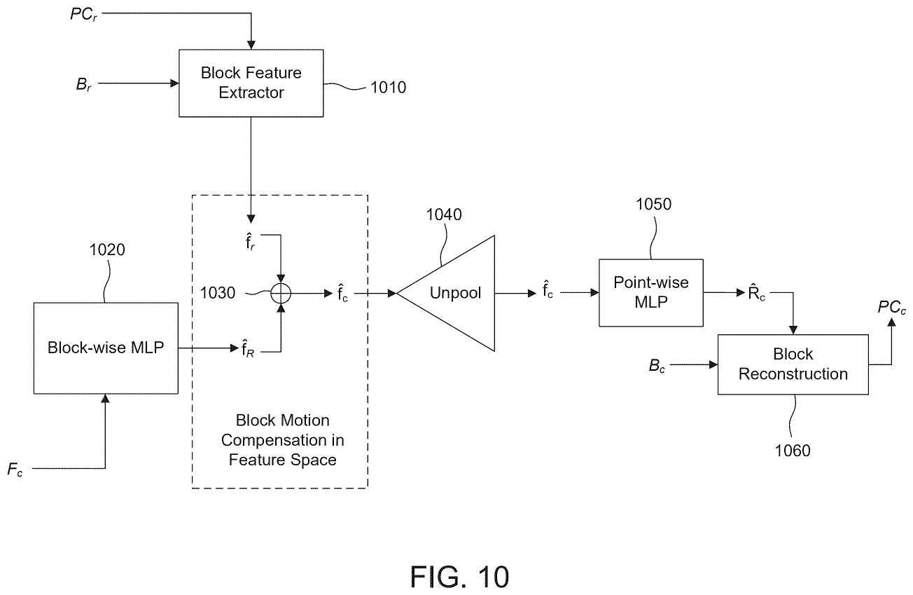

The block diagram of the BSᵢₙₜₑᵣ module is illustrated in FIG. 10, according to an embodiment. The Motion Prediction module in FIG. 5 predicts the block position on the reconstructed reference point cloud PCᵣ. This block position Bᵣ and the PCᵣ can be served as inputs for extracting the feature \hat{f}ᵣ of the reconstructed reference frame. The points residing in the predicted block are fed to the “Block Feature Extractor” (1010), which is previously depicted in FIG. 8. This extractor extracts the block-wise feature \hat{f}ᵣ on the reference frame.

At the same time, the decoded and upsampled residual feature F_{c} is fed to a block-wise MLP (1020) to output \hat{f}_{R}. These two features are added (1030) together via the summation module ⊕ to form the current block-wise feature \hat{f}_{c}. We note that in one embodiment, the summation module ⊕ is implemented by simple vector addition i.e., \hat{f}_{c}=\hat{f}ᵣ+\hat{f}_{R}. In another embodiment, the summation module is implemented by a neural network. It first concatenates the two features \hat{f}ᵣ and \hat{f}_{R}, followed by passing it to a series of convolutional layers, then the output of the convolutional layers is the feature \hat{f}_{c}. This current feature can be un-pooled (1040) to become \hat{f}_{c}, then fed to a final pointwise MLP (1050) to reconstruct the point-wise local coordinates \hat{R}_{c}. These local coordinates corresponding to the reconstructing points in the block are added to each corresponding block position B_{c} and the final positions of the current PC_{c} are reconstructed (1060).

### Voxel Analysis and Voxel Synthesis

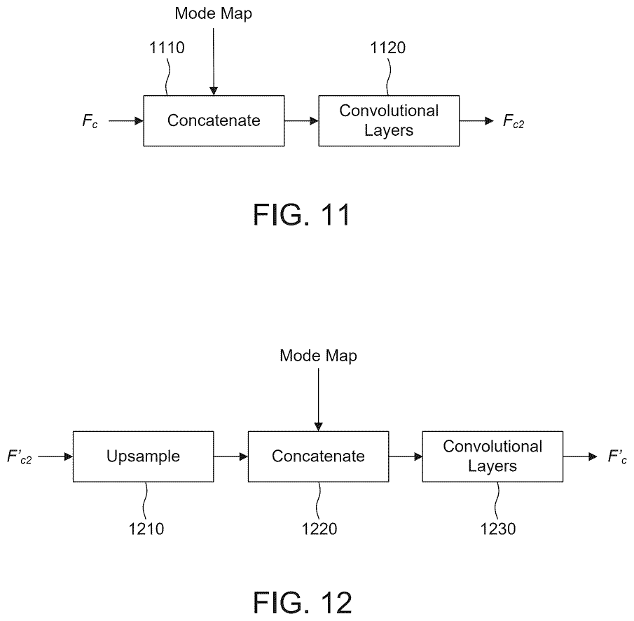

The block diagram of the “voxel analysis module” (i.e., VA) is shown in FIG. 11, according to an embodiment. The VA module takes the mode map (indicating which blocks are inter mode blocks and which are intra mode blocks) and the feature map F_{c} as inputs. In one embodiment, the mode map is a binary map which uses 0 to indicate inter mode block and uses 1 to indicate intra mode block. In another embodiment, it uses 1 to indicate inter mode block and uses 0 to indicate intra mode block. Firstly, the feature map F_{c} and the mode map are concatenated (1110) in FIG. 11, leading to an augmented feature map. The augmented feature map is then passed to a series of convolutional layers (1120) for aggregation and downsampling, leading to the downsampled feature map, denoted as F_{c2}.

The block diagram of the “voxel synthesis module” (i.e., VS) is shown in FIG. 12, according to an embodiment. The VS module takes the mode map and the downsampled feature map F′_{c2} as inputs. It first performs voxel upsampling (1210) to the feature map F′_{c2}, so as to match its size with the feature map F_{c} on the encoder side. The output feature map is then concatenated (1220) with the mode map, leading to an augmented feature map. The augmented feature map is then passed to a series of convolutional layers (1230) for aggregation and upsampling, leading to the output feature map F′_{c}.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of decoding a point cloud frame in a dynamic point cloud sequence, comprising:
decoding motion information for a current point cloud block, wherein said current point cloud block is inter coded;
obtaining a reference point cloud block in a previously reconstructed point cloud frame for predicting said current point cloud block, based on said motion information for said current point cloud block;
obtaining a feature representative of said reference point cloud block, using at least a point-based neural network;
decoding residual feature information for said current point cloud block that represents a difference between said current point cloud block and said reference point cloud block;
obtaining a feature for said current point cloud block, based on said decoded residual feature information and said feature representative of said reference point cloud block; and
reconstructing positions of 3D points in said current point cloud block based on said feature for said current point cloud block, using at least another point-based neural network.

2. (canceled)

3. The method of claim 1, further comprising:
decoding information indicating positions of occupied blocks in said point cloud frame.

4. The method of claim 3, further comprising:
decoding information indicating coding modes of respective occupied blocks in said point cloud frame.

5. The method of claim 1, further comprising:
concatenating said residual feature information and said feature representative of said reference point cloud block; and
applying a series of convolutional layers to said concatenated feature to form said feature representative of said current point cloud block.

6. The method of claim 1, wherein said at least another point-based neural network includes a series of MLP layers.

7. The method of claim 1, wherein said decoding residual feature information for said current point cloud block comprises:
decoding a downsampled feature map, wherein said downsampled feature map is augmented by data indicating whether an intra or inter mode is used for a corresponding block in a current point cloud frame; and
upsampling and aggregating said downsampled feature map to obtain said residual feature information.

8. The method of claim 1, wherein another block in a current point cloud frame is decoded in an intra mode without a reference point cloud frame.

9. A method of encoding a point cloud frame in a dynamic point cloud sequence, comprising:
estimating motion information for a current point cloud block based on a current point cloud frame and a previously reconstructed point cloud frame;
obtaining a reference point cloud block from a previously reconstructed point cloud frame for predicting said current point cloud block, based on said motion information for said current point cloud block;
obtaining a first feature representative of said current point cloud block and a second feature representative of said reference point cloud block, using at least a point-based neural network;
obtaining a difference between said first feature representative of said current point cloud block and said second feature representative of said reference point cloud block to form a residual feature; and
encoding said residual feature.

10. (canceled)

11. The method of claim 9, further comprising:
encoding information indicating positions of occupied blocks in said point cloud frame.

12. The method of claim 11, further comprising:
encoding information indicating coding modes of respective occupied blocks in said point cloud frame.

13. The method of claim 9, wherein said obtaining a difference comprises:
concatenating said first feature representative of said current point cloud block and said second feature representative of said reference point cloud block; and
applying a series of convolutional layers to said concatenated feature to form said difference.

14. The method of claim 9, wherein said first feature representative of said current point cloud block and said second feature representative of said reference point cloud block are obtained by a shared point-based neural network.

15. The method of claim 9, further comprising:
downsampling and aggregating a feature map to form a downsampled feature map, wherein said feature map is augmented by data indicating whether an intra or inter mode is used for a corresponding block in said current point cloud frame; and
encoding said downsampled feature map.

16. The method of claim 9, wherein another block in said current point cloud frame is encoded in an intra mode without a reference point cloud frame.

17-18. (canceled)

19. An apparatus for decoding a point cloud frame in a dynamic point cloud sequence, comprising one or more processors and at least one memory coupled to said one or more processors, wherein said one or more processors are configured to:
decode motion information for a current point cloud block, wherein said current point cloud block is inter coded;
obtain a reference point cloud block in a previously reconstructed point cloud frame for predicting said current point cloud block, based on said motion information for said current point cloud block;
obtain a feature representative of said reference point cloud block, using at least a point-based neural network;
decode residual feature information for said current point cloud block that represents a difference between said current point cloud block and said reference point cloud block;
obtain a feature for said current point cloud block, based on said decoded residual feature information and said feature representative of said reference point cloud block; and
reconstruct positions of 3D points in said current point cloud block based on said feature for said current point cloud block, using at least another point-based neural network.

20. The apparatus of claim 19, wherein said one or more processors are further configured to:
concatenate said residual feature information and said feature representative of said reference point cloud block; and
apply a series of convolutional layers to said concatenated feature to form said feature representative of said current point cloud block.

21. The apparatus of claim 19, wherein said at least another point-based neural network includes a series of MLP layers.

22. An apparatus for encoding a point cloud frame in a dynamic point cloud sequence, comprising one or more processors and at least one memory coupled to said one or more processors, wherein said one or more processors are configured to:
estimate motion information for a current point cloud block based on a current point cloud frame and a previously reconstructed point cloud frame;
obtain a reference point cloud block from a previously reconstructed point cloud frame for predicting said current point cloud block, based on said motion information for said current point cloud block;
obtain a first feature representative of said current point cloud block and a second feature representative of said reference point cloud block, using at least a point-based neural network;
obtain a difference between said first feature representative of said current point cloud block and said second feature representative of said reference point cloud block to form a residual feature; and
encode said residual feature.

23. The apparatus of claim 22, wherein said one or more processors are further configured to:
concatenate said first feature representative of said current point cloud block and said second feature representative of said reference point cloud block; and
apply a series of convolutional layers to said concatenated feature to form said difference.

24. The apparatus of claim 22, wherein said first feature representative of said current point cloud block and said second feature representative of said reference point cloud block are obtained by a shared point-based neural network.
